(19) United States
(12) Patent Application Publication
(10) Pub. No.: US 2010/0281670 A1
(43) Pub. Date: Nov. 11, 2010

(54) TUBE REPAIR INSERT

(75) Inventor: Roger Adelman, Villa Hills, KY (US)

Correspondence Address: WOOD, HERRON & EVANS, LLP, 2700 CAREW TOWER, 441 VINE STREET, CINCINNATI, OH, 45202, US

(73) Assignee: DOUGLAS L. HOLLAENDER ENTERPRISES, INC., Loveland, OH (US)

(21) Appl. No.: 12/435,461

(22) Filed: May 5, 2009

(51) Int. Cl. B23P 6/00

(52) U.S. Cl. 29/402.16

(57) ABSTRACT

A tube can be repaired from its interior surface by inserting into the tube a cylindrical repair member The cylindrical repair member is a memory metal which has a first martensitic size that is less than the internal diameter of the tube, and a second austenitic size that is at least as large as or larger than the internal diameter of the tube. The cylindrical repair member is inserted into the tube in the martensitic state and heated, causing it to revert to the austenitic state thereby expanding and covering said hole, forming a tight bond with the internal surface of the tube.

### BACKGROUND OF THE INVENTION

There are numerous ways to repair holes or punctures in metal tubing. If the exterior of the tube is accessible, one can attach a sleeve to the exterior of the metal tube and clamp the sleeve onto the tube. Also, if the exterior is accessible, the tube can be replaced. In certain applications, the exterior of the tube is not accessible. For example, in heat exchangers the exterior of the tube cannot be accessed without taking the entire heat exchanger apart. Therefore, any leaks in such tubes must be repaired from the inside, or the tube must be plugged.

### SUMMARY OF THE INVENTION

The present invention is premised on the realization that a hole in a metal tube can be repaired from its interior surface by inserting a hollow cylindrical member into the tube positioned over the hole and causing the cylindrical member to expand. More particularly, the cylindrical member is formed from a memory metal, which is formed at a first size, and then deformed by forcing it through a cylindrical die, reducing its diameter. The reduced diameter cylinder is inserted into the tube and heated, causing it to revert to its larger state, expanding and pressing against the side of the tube covering any hole and repairing the tube.

The objects and advantages of the present invention will be further appreciated in light of the following detailed description and drawings in which:

### BRIEF DESCRIPTION OF THE DRAWING

FIG. 1 is a diagrammatic depiction of a cylindrical repair member inserted into a metal tube;

FIG. 2 is a cross sectional view of a tube being repaired;

FIG. 3 is a diagrammatic depiction of a method of forming the cylindrical repair member used in FIG. 1.

### DETAILED DESCRIPTION

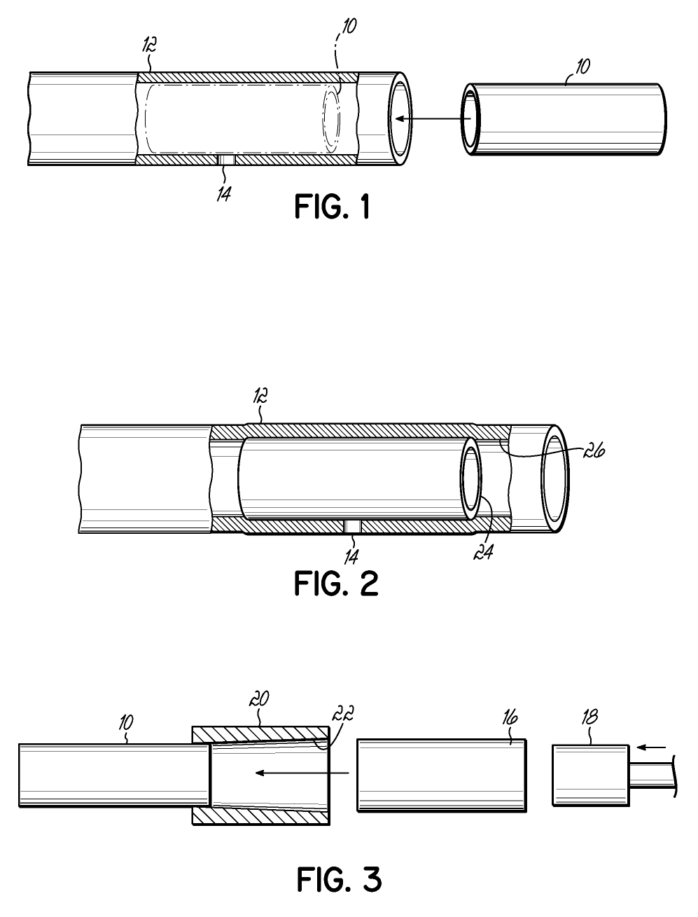

The present invention utilizes a hollow cylindrical repair member or repair tube 10 to repair a metal tube, such as 12 shown in FIG. 1, which has a hole 14.

The repair tube 10, more particularly, is formed from a memory metal. Memory metal is a metal that can be deformed and subsequently caused to go back to its original shape. Nitinol is one of the best memory metals. This is formed from a combination of nickel and titanium. Nitinol can exist in either of two fundamental crystalline structures, a lower temperature arrangement of atoms called martensite, and a higher temperature arrangement called austenite.

Nitinol is obtained in a basic polygrain austenitic form and can be cut and shaped into a desired form to be memorized. The material is then annealed, still in the austenitic state at 500° C. to relieve any residual stress from the formation of the geometric shape. The anneal sets the material's memory.

The formed and memorized part is then chilled until the atomic structure becomes martensite. Once in the martensitic state, the bonds between the atoms can be deformed elastically. The deformed martensitic material, when heated, reverts to austenite, with its atoms being held at their original locations. Thus, the part returns to its memorized shape.

Thus, the repair tube 10, as shown in FIG. 1, is in the martensitic state with an outer diameter slightly less than the inner diameter of tube 12. The martensitic repair tube 10 is formed by initially forming a repair tube 16 from a memory metal, particularly Nitinol, which is in the austenitic state. Repair tube 16 can be formed or machined from austenitic memory metal by any well-known manner. The formed repair tube 16 will have an exterior diameter that is at least equal to, and preferably slightly larger than, the internal diameter of the tube 12 that is being repaired. It may be desirable for repair tube 16 to have an exterior diameter slightly larger than the interior diameter of tube 12 so that when it expands it will cause tube 12 to actually bulge slightly, as shown in FIG. 2. However, it should not be so large as to cause the tube 12 to rupture. Repair tube 16 is then annealed at about 500° C. for 1-4 hours. The austenitic repair tube 16 is then chilled to at least approximately 0° F., generally to −50° F., causing it to transform into the martensitic state. The chilled repair tube 16, now in the martensitic state, is forced by for example, a ram 18 through a die 20 having an internal tapered surface 22. Forcing repair tube 16 through die 20 reduces the external diameter of the repair tube 16, forming the martensitic repair tube 10, which has an external diameter, again, slightly less than the internal diameter of tube 12. In order to achieve a desired diameter, repair tube 16 may have to be forced through more than one die, each with a slightly reduced diameter.

As shown in FIG. 1, this martensitic repair tube 10 is inserted into tube 12 in an area which overlies a hole 14. Repair tube 10 is then heated using, for example, a torch or an electric resistance heater, generally to a temperature of about 200° F. This causes the repair tube 10 to expand, as shown in FIG. 2, and form an enlarged repair tube 24 having the same dimensions as repair tube 16 prior to being forced through die 20. Thus, expanded repair tube 24 presses against the interior wall 26 of tube 12 forming a tight seal, allowing the tube 12 to be used. This provides a quick reliable and inexpensive tube repair which requires only access to the interior of the tube.

This has been a description of the present invention along with the preferred method of practicing the present invention. However, the invention itself should be defined only by the appended claims, WHEREIN WE CLAIM:

What is claimed is:

1. A method of repairing a hole through a tube comprising inserting a cylindrical hollow member into said tube said member overlying said hole said cylindrical hollow member being in a martensitic state;
wherein said member has an austenitic size which is at least equal to the internal diameter of said tube and a martensitic size which is less than the internal diameter of said tube;
heating said cylindrical hollow member while in said martensitic state whereby said cylindrical hollow member reverts to an austenitic state and compresses against the internal wall of said tube.

2. The method claimed in claim 2 wherein said tube has an austenitic size slightly greater than the internal diameter of said tube.

3. The method claimed in claim 2 wherein said cylindrical hollow member comprises Nitinol.
